(19) United States
(12) Patent Application Publication
(10) Pub. No.: US 2013/0054130 A1
(43) Pub. Date: Feb. 28, 2013

(54) NAVIGATION SYSTEM, METHOD OF POSITION ESTIMATION AND METHOD OF PROVIDING NAVIGATION INFORMATION

(71) Applicants: Zhou Ye, Foster City, CA (US); Shun-Nan Liou, Kaohsiung City (TW); Ying-Ko Lu, Taoyuan County (TW); Chin-Lung Lee, Taoyuan County (TW)

(72) Inventors: Zhou Ye, Foster City, CA (US); Shun-Nan Liou, Kaohsiung City (TW); Ying-Ko Lu, Taoyuan County (TW); Chin-Lung Lee, Taoyuan County (TW)

(73) Assignee: CYWEE GROUP LIMITED, TORTOLA (VG)

(21) Appl. No.: 13/662,560

(22) Filed: Oct. 29, 2012

Related U.S. Application Data
(63) Continuation-in-part of application No. 13/072,794, filed on Mar. 28, 2011.
(60) Provisional application No. 61/554,973, filed on Nov. 3, 2011.

(51) Int. Cl. G01C 21/16; G06F 19/00

(52) U.S. Cl. 701/409; 701/500; 702/150

(57) ABSTRACT

A hybrid-computing navigation system worn by a user includes a modified motion sensor group which includes 9-axis or 10-axis motion sensors that are built-in, and a host device configured for providing navigation information, in which the modified motion sensor group is worn on the user so that a moving direction of the user is the same as a heading direction calculated from the modified motion sensor group. The modified motion sensor group provides step counting and absolute orientation in yaw, roll and pitch using a sensor fusion technique. The navigation system further includes at least one wireless sensor at wifi hot spot to perform sensor fusion for obtaining an absolute position of an estimated position of the user. Sensor fusion combining with location map are used to perform location map matching and fingerprinting. A method of position estimation of a user using the navigation system is also disclosed.

### CROSS-REFERENCE TO RELATED APPLICATIONS

This application is a non-provisional of U.S. provisional application Ser. No. 61/554,973, filed on Nov. 3, 2011, currently pending, and is a continuation-in-part application of U.S. non-provisional application Ser. No. 13/072,794, filed on Mar. 28, 2011, currently pending. The contents of the above-mentioned patent applications are hereby incorporated by reference herein in their entirety and made a part of this specification.

### BACKGROUND OF THE INVENTION

1. Field of the Invention

The present invention relates to a navigation system, especially to a hybrid-computing navigation system, and method of position estimation utilizing a plurality of motion sensors.

2. Description of Related Art

A number of conventional techniques for determining the position of an electronic device using radio frequency signals are found today. Some popular techniques are directed to the use of the Global Positioning System (GPS), in which multiple satellites orbiting Earth transmit radio frequency signals that enable a GPS receiver to determine its location and position. Thus, people today have heavily relied on Global Positioning System (GPS) for providing navigation and location information. However, GPS is not an optimal positioning system because of having many drawbacks. For example, some of the drawbacks of the GPS are as follow: GPS does not work well under trees, or inside parking lots and tunnels; and GPS also does not work well under trolley wire, or between tall buildings (in an urban jungle environment), or in bad weather conditions. Additionally, GPS may have an average position error of about 20-25 meters, which is considered quite significant amount when considered under certain precision positioning applications. The operating principle of GPS is based on the Time Difference of Arrival (TDOA) method using GPS satellites and GPS receiver. Another conventional positioning method is Wi-Fi positioning. Regarding to the Wi-Fi positioning method, a triangulation method is utilized in Wi-Fi positioning. However, such location estimation method ends up with a large variation and deviation in the position and location estimation result. That is to say, the location estimated by Wi-Fi positioning possesses a large uncertainty.

FIG. 1 shows a simulation example of the Wi-Fi positioning error found during a test conducted inside a shopping mall. Referring to FIG. 1, a user carries a Wi-Fi receiver and walks from point A to point B inside the shopping mall. The solid line indicates the actual walking path of the user, while the dashed line represents the estimated path predicted by the Wi-Fi positioning system. By comparing the estimated path provided by the Wi-Fi positioning system against the actual walking path of the user, the estimated path obtained by the Wi-Fi positioning has low accuracy.

Referring to FIG. 2, another example of an improved Wi-Fi positioning system configured using an increased number of Wi-Fi hot spots (or also referred to as Wi-Fi access points) is shown. In FIG. 2, the improved Wi-Fi positioning system has gone from a total of having just 4 Wi-Fi hot spots to a total of having 9 Wi-Fi hot spots, thereby adding 5 additional Wi-Fi hot spots. However, the reduction of positioning error for the improved Wi-Fi positioning system comes at a serious drawback of increased costs as well as higher power consumption at the Wi-Fi receiver carried by the user.

Therefore, there is room for improvement within this field of art.

### BRIEF DESCRIPTION OF THE DRAWINGS

FIG. 1 shows a simulation conducted under a conventional Wi-Fi positioning system taken place inside a shopping mall.

FIG. 2 shows another simulation conducted under an improved version of conventional Wi-Fi positioning taken place inside a shopping mall using extra number of Wi-Fi hot spots.

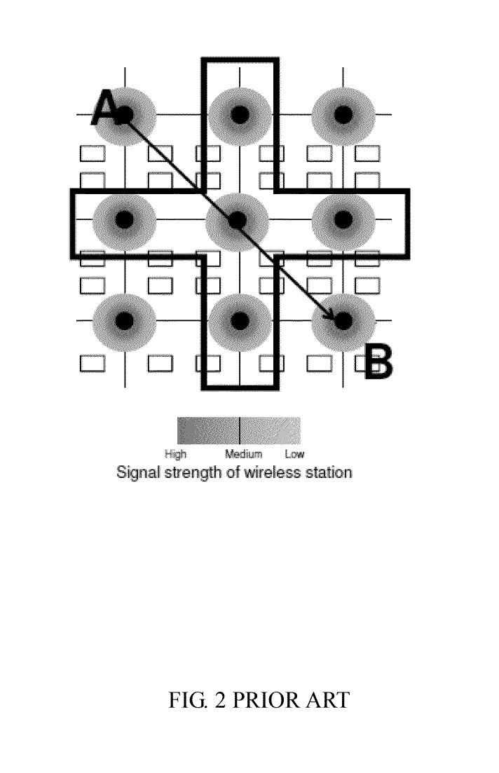

FIG. 3 shows a simulation conducted under a hybrid-computing navigation system configured using Wi-Fi hot spots with a user carrying a Wi-Fi receiver that is configured with 9-axis motion sensors and a 10-axis sensor fusion sensor according to an embodiment of the present invention.

FIG. 4 shows a method of position estimation using the hybrid-computing navigation system configured with 9-axis motion sensors and 10-axis sensor fusion sensor according to a first embodiment of present invention.

FIG. 5 illustrates the roll, yaw and pitch coordinates defined with respect to the X-axis, Y-axis, and Z-axis.

FIG. 6 shows a method for calculating a step count of the user carrying the Wi-Fi receiver according to one embodiment of the present invention.

FIG. 7 shows a method of map matching with the position estimation using the hybrid-computing navigation system according to one embodiment of the present invention.

FIG. 8 shows the hybrid-computing navigation system of another embodiment of the present invention using a modified motion sensor group, which is attached to the human body.

FIG. 9 shows the hybrid-computing navigation system of the yet another embodiment which includes the modified motion sensor group and a mobile device.

FIG. 10 shows a wearable modified motion sensor group disposed between the neck and the waist of the user according to one embodiment of the present invention.

FIG. 11 shows a motion sensor group disposed in a necklace which the user wears around his neck according to another embodiment of the present invention.

FIG. 12 shows a motion sensor group disposed between the neck and the waist of the user, and the motion sensor group is connected to a headphone according to yet one more embodiment of the present invention.

FIG. 13 shows the motion sensor group embedded in a headphone transceiver which provides a headphone jack according to still another embodiment of the present invention.

FIG. 14 shows a motion sensor group embedded in the wireless transceiver according to still yet another embodiment of the present invention.

FIG. 15 shows a motion sensor group embedded in the mobile device which is disposed between the neck and the waist of the user, and the motion sensor group being connected to a headphone according to a second embodiment of the present invention.

### SUMMARY OF THE INVENTION

An objective of the present invention is to provide a hybrid-computing navigation system using a configuration of Wi-Fi hot spots together with a user that is configured with 9-axis motion sensors (of 3-axis G, 3-axis Gyro, and 3-axis Magnetic) and a 10-axis Sensor Fusion sensor (1-axis Altimeter).

Another objective of the present invention is to form a hybrid-computing navigation system by combining conventional Wi-Fi positioning system together with 9-axis motion sensors and CyWee™ sensor fusion technology to form a positioning system without requiring any additional power consumption at the Wi-Fi receiver end.

Another objective of the present invention is to provide a method of position estimation using the hybrid-computing navigation system configured with 9-axis motion sensors and 10-axis Sensor Fusion sensor.

To achieve the above-said objectives, the present invention provides a method of position estimation using the hybrid-computing navigation system, comprising the following steps: an initial position is set using a 10-axis sensor; using a 9-axis motion sensor incorporating sensor fusion technology from Cywee™, a plurality of step counts of a user, a traveling distance based on the step counts of the user, and the height of the user by using barometer are obtained, respectively; using wireless sensor triangulation calculations performed between a user configured with motion sensors and a plurality of Wi-Fi hot spots, the location-based data on the triangulation calculation/RSSI are obtained; using a plurality of motion parameters and wireless parameters to output fusion, the estimated position of the user is obtained based on a fusion of motion parameters and wireless parameters; using positioning correction, a location map matching is performed based on the location map information and the motion sensor data, and wireless sensor fingerprinting is performed based on the wireless pattern or the wireless location map measured in advance; the current estimated position of the user is updated based upon the results from the positioning correction and the location map matching.

To achieve the above-said objectives, the present invention provides a method for calculating step counts of the user, including the following steps: an initial position of the user is set; using 10-axis sensor fusion technology from Cywee™ and Kalman filter, the orientation and height of the Wi-Fi receiver are obtained; using roll, yaw and pitch data, gravity change and linear acceleration are decoupled; the step counts of the user are determined by calculating linear acceleration obtained from the walking motion of the user, in which the traveling distance of the user is calculated based on the step count data; the traveling distance and yaw angle are combined to calculate the next estimated position of the user based on data gathered from a plurality of motion sensors located in the wireless receiver.

To achieve the above-said objectives, the present invention provides a navigation system worn by a user, comprising a modified motion sensor group comprising a plurality of motion sensors, which are worn by the user; and a host device configured for providing navigation information, wherein the modified motion sensor group is worn on the user so that a moving direction of the user is the same as a heading direction calculated from the modified motion sensor group. In addition, the modified motion sensor group provides step counts and absolute orientation in yaw, roll and pitch using sensor fusion technology from CyWee Group Limited which is configured for 9-axis motion sensors and 1 axis altimeter.

To achieve the above-said objectives, the present invention provides the navigation system, using 10-axis sensor fusion, further comprising a wireless sensor to perform sensor fusion for obtaining an absolute position of an estimated position of the user and calibration for the error of 10-axis motion sensors, and being able to combine with a location map to perform location map matching and fingerprinting.

To achieve the above-said objectives, the present invention provides the motion sensors of the navigation system to be able to communicate with the host device to send sensor data to the host device, capable of further connecting to an ear phone for receiving audio guidance from the host device.

To achieve the above-said objectives, the present invention provides a plurality of motion sensors to include at least one G-sensor, at least one gyro-sensor, and at least one magnetic-sensor in one or more embodiments.

To achieve the above-said objectives, the present invention also provides a plurality of motion sensors to include at least one G-sensor, at least one gyro-sensor, at least one magnetic-sensor, and an altimeter in one or more embodiments.

The present invention provides the following beneficial effects:

The advantages of the hybrid-computing navigation system with motion sensor and sensor fusion technology are as follows: this navigation system has more precise dead reckoning, and with the 10-axis capability, absolute positioning capability thereof is more precise than other systems which uses 6-axis only; furthermore, improved accuracy on heading is also achieved; lower infrastructure cost and power consumption can be achieved since conventional Wi-Fi navigation system requires constant periodic Wi-Fi triangulations to be performed thereby requiring more power consumption than the hybrid-computing navigation system with sensor fusion, which only requires lesser number of occasional position updates; and fewer Wi-Fi nodes are required by the hybrid-computing navigation system.

The benefits of the motion sensor-based algorithm for the hybrid-computing navigation system are as follows: such motion sensor algorithm can coast thru dead zones; it can keep the system alive with sparse Wi-Fi signal; it is able to provide enhanced GPS/AGPS position while the signal is weak; it can also provide indoor/outdoor seamless position transition; and it can be used reliably in more areas; this type of motion sensor-based algorithm allows for the adaptation for Augmented Reality (AR) because implementation of AR needs accurate orientation and position information.

### DETAILED DESCRIPTION OF THE INVENTION

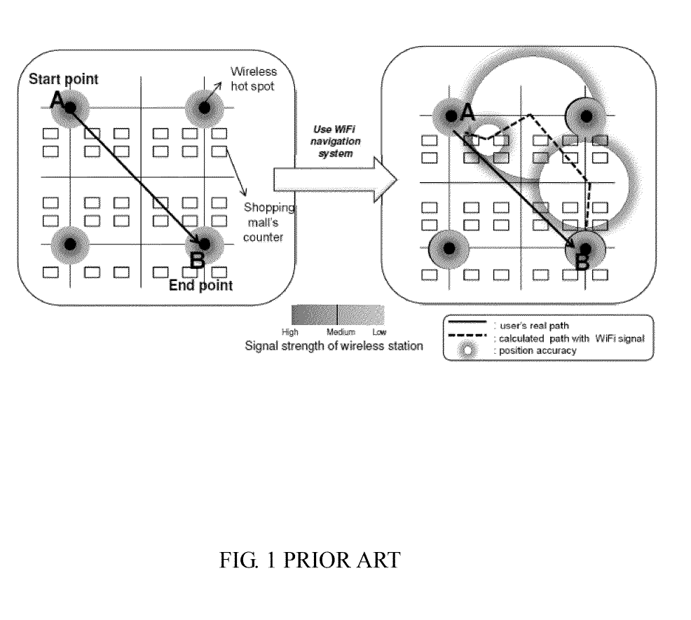

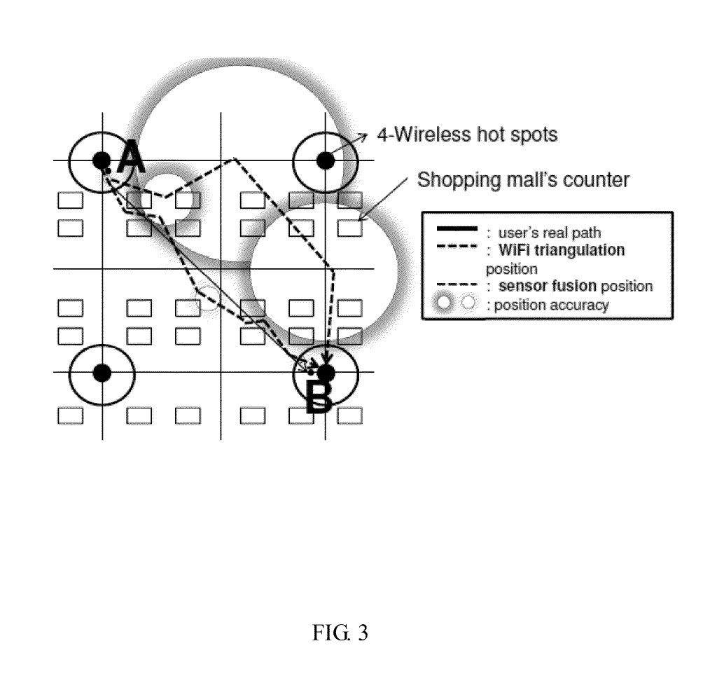

Referring to FIG. 3, a hybrid-computing navigation system using a conventional configuration of Wi-Fi hot spots incorporating together with a user carrying a Wi-Fi receiver that is configured with 9-axis motion sensors (of 3-axis G, 3-axis Gyro, 3-axis Magnetic) and a 10-axis Sensor Fusion sensor (1-axis Altimeter) according to an embodiment of the present invention is illustrated. FIG. 3 shows the hybrid-computing navigation system being outfitted with 4 Wi-Fi hot spots, and the walking path of the user carrying the Wi-Fi receiver which includes the 9-axis motion sensors and the 10-axis sensor fusion altimeter sensor. Referring to FIG. 3, the dashed line that is shown to be adjacent or very close to the actual path of the user represents the estimated path based upon calculations provided from the hybrid-computing navigation system of Wi-Fi hot spots and the motion sensors of the present invention. The combination of the conventional Wi-Fi positioning system together along with the 9-axis motion sensors and the CyWee™ sensor fusion technology form a much improved accurate positioning system that provides a “direct route” (the “direct route” means to have fewer deviations as compared to the estimated route, i.e. “indirect route” as shown in FIG. 1) for the user to go from point A to point B with 100% coverage there between, using the limited conventional Wi-Fi network without requiring any additional power consumption at the Wi-Fi receiver end (the Wi-Fi receiver is carried on the user while walking along the actual path shown in solid line indicated by an arrow).

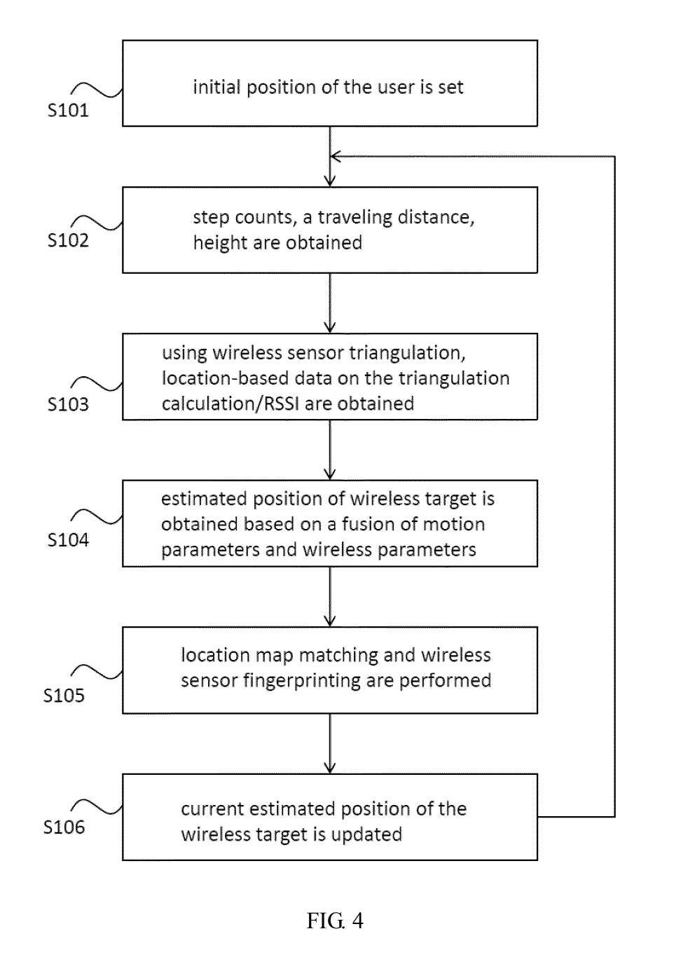

In FIG. 4, according to a first embodiment, a method of position estimation using the hybrid-computing navigation system with 9-axis motion sensors and 10-axis Sensor Fusion sensor as described in the embodiment includes the following steps:

Step S101: An initial position of the user is set using a 10-axis sensor (S101).

Step S102: Using a 9-axis motion sensor incorporating sensor fusion technology from Cywee™, a plurality of step counts of a user, a traveling distance based on the step counts of the user, and a height of the user by using barometer are obtained, respectively (S102).

Step S103: Using wireless sensor triangulation calculations performed between a wireless target of a user carrying a Wi-Fi receiver configured with the 9-axis motion sensors and 10-axis sensor fusion sensor and a plurality of Wi-Fi hot spots, the location-based data on the triangulation calculation/RSSI are obtained (S103).

Step S104: Using a plurality of motion parameters and wireless parameters to output fusion, the estimated position or location of the wireless target (i.e. the user) is obtained based on a fusion of motion parameters and wireless parameters (S104);

Step S105: Using positioning correction/calibration, a location map matching is performed based on the location map information and the motion sensor data, and wireless sensor fingerprinting is performed based on the wireless pattern or the wireless location map measured in advance (S105).

Step S106: The current estimated position of the wireless target carrying the Wi-Fi receiver is updated based upon the results from the positioning correction and the location map matching (S106).

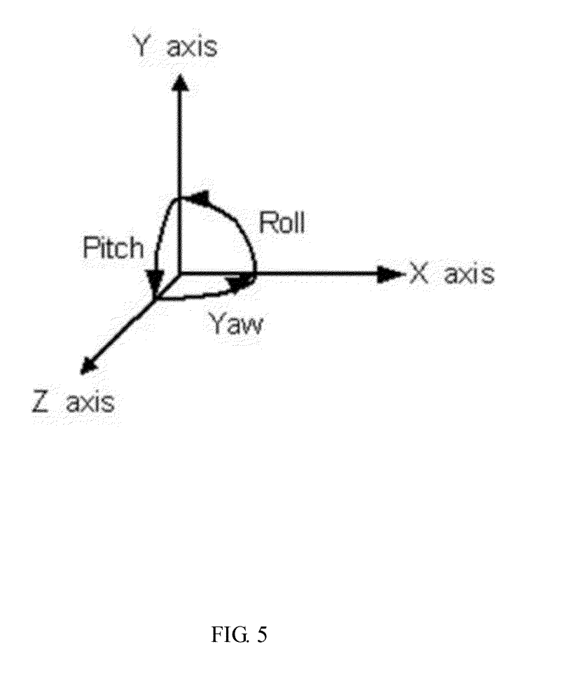

Referring to FIG. 5, the roll, yaw and pitch coordinate are defined with respect to the X-axis, Y-axis, and Z-axis, respectively.

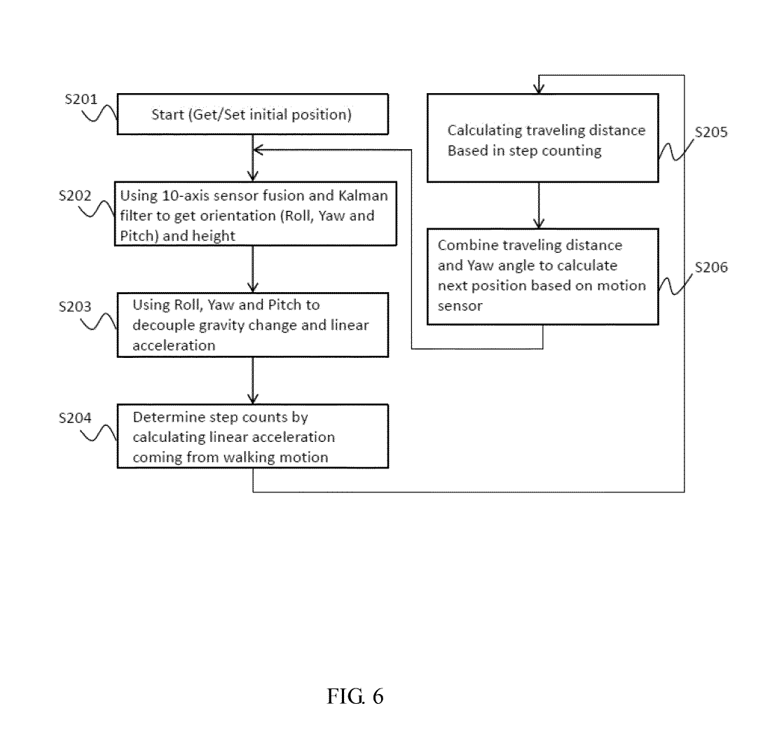

Referring to FIG. 6, a method for calculating step counts of the user carrying the Wi-Fi receiver according to an embodiment of the present invention is described. In this embodiment, the method for calculating the step counts includes the following steps:

Step S201: An initial position of a user is set (S201);

Step S202: Using 10-axis sensor fusion technology from Cywee™ and Kalman filter, the orientation (roll, yaw and pitch) and the height of the wireless target (Wi-Fi receiver) are obtained (S202);

Step S203: Using roll, yaw and pitch data, the gravity change and the linear acceleration are decoupled (S203);

Step S204: The step counts of the user are determined by calculating the linear acceleration obtained from the walking motion of the user (S204),

Step S205: The traveling distance of the user is calculated based on the step count data (S205); and

Step S206: The traveling distance and yaw angle are combined to calculate the next estimated position of the user based on data gathered from a plurality of motion sensors located in the wireless receiver (S206).

Upon completion of Step S206, one can repeat from Step S202 if necessary until completion.

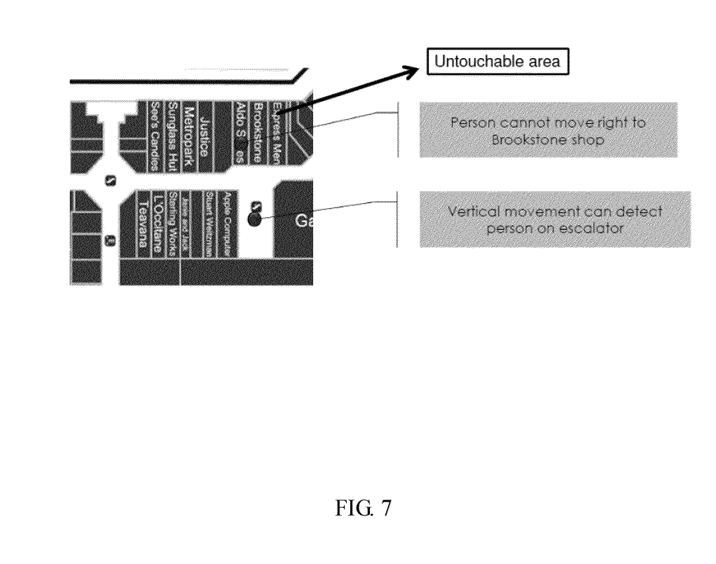

Furthermore, another embodiment of the present invention includes map matching capability. In FIG. 7, a method of map matching with the position estimation using the hybrid-computing navigation system of according to an embodiment of the present invention is described. When the estimated position end up being as an unreachable or an untouchable position, such estimated “unreachable” position may be thereby shifted/modified/switched to a nearby adjacent reachable position. According to the map matching method of the this embodiment, the vertical movement or any vertical change in the position of the wireless target/user due to transporting by an escalator or an elevator may be also detected.

Referring to FIG. 7, according to an another embodiment, a simulation of the hybrid-computing navigation system configured with 10-axis sensor fusion technology operating under Wi-Fi triangulation location estimation technique and using Received Signal Strength Indicator (RSSI) values in combination with map matching is shown. The hybrid-computing navigation may be performed by combining the Wi-Fi positioning data, the map matching technique, and results obtained from 10-axis sensor and motion sensors.

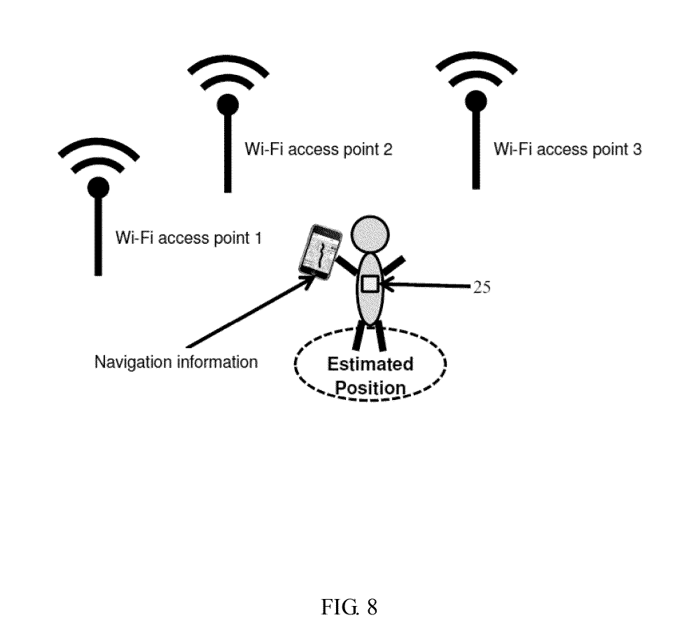

Referring to FIG. 8, a yet another embodiment of the hybrid-computing navigation system using a modified motion sensor group 25, which is attached to the human body, and Wi-Fi positioning technique may generate a more accurate estimated position thereof. The modified motion sensor group 25 includes a G sensor, a gyro sensor and a magnetic sensor, in which a sensor fusion technology from CyWee Group Limited provides further enhancement to the motion sensors for providing step counting and absolute orientation (yaw, roll and pitch) capability. In addition, the modified motion sensor group 25 thus may include 9-axis (g-sensors, gyro-sensors, and magnetic-sensors) motion sensors and 1-axis altimeter.

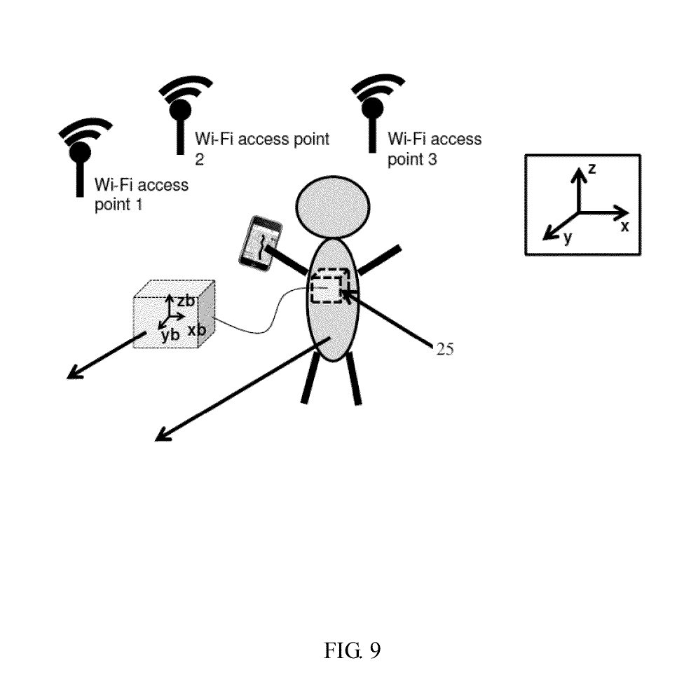

In FIG. 9, the hybrid-computing navigation system of the yet another embodiment has the moving direction to be the same as the heading direction after sensor fusion, and includes the modified motion sensor group 25 and a mobile device. The modified motion sensor group 25 is disposed on the human body/user. Additionally, the modified motion sensor group 25 may be disposed on the human body or user between the neck and the waist. The heading direction of the modified motion sensor group 25 is substantially identical to a moving direction of the user. The mobile device is connected to the modified motion sensor group 25 and receives the heading direction of the modified motion sensor group 25 that is substantially identical to the moving direction of the user. In this embodiment, the heading direction of the modified motion sensor group 25 is designated as “yb” and is the same as the moving direction of the user. Therefore, the moving direction of the user is obtained and may be used in combination of Wi-Fi positioning, map matching technique or 10-axis motion sensor (using sensor fusion).

In this embodiment, the mobile device includes a motion processing unit and a position calculation unit. The motion processing unit obtains moving information in the coordinates of yaw, roll and pitch. The motion processing unit extracts a gravity change and a linear acceleration from the moving information. The motion processing unit determines step counts by processing the linear acceleration. The position calculation unit calculates a traveling distance according to the step counts, and then determines a current estimated position according to the previous estimated position, the traveling distance and the moving information.

In this embodiment, the 10-axis motion sensor is utilized to set an initial position, obtain orientation based on the 9-axis motion sensor fusion results, obtain step counts, obtain a traveling distance based on the step counts, and obtain the height by barometer.

In this embodiment, the wireless sensor triangulation location estimation technique is utilized to obtain the real-time location of the estimated position based on triangulation calculations/RSSI. In this embodiment, the motion parameters and the wireless parameters are analyzed or combined to obtain the current estimated position. In this embodiment, positioning correction and calibration data are utilized to perform map matching based on the location map information and the motion sensor data and to perform wireless sensor fingerprinting based on wireless pattern measured in advance.

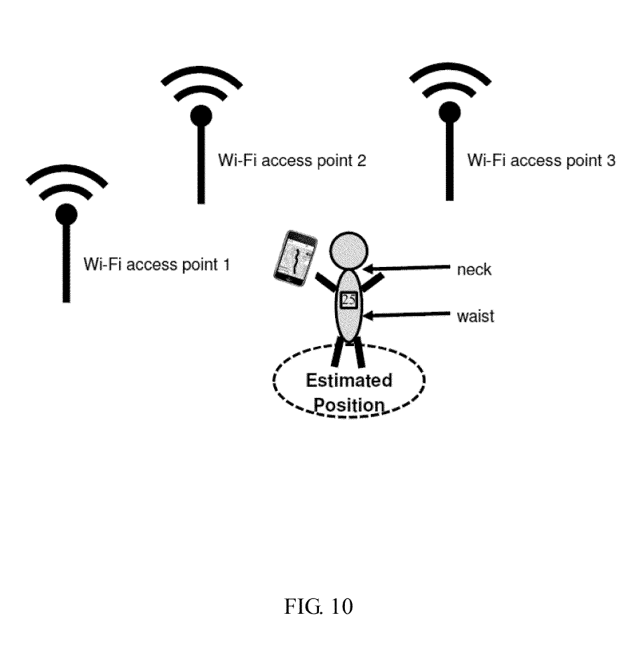

In FIG. 10, according to one embodiment of the present invention, a wearable modified motion sensor group 25 is disposed between the neck and the waist of the user to ensure that the moving direction of the user is the same as the heading direction of the modified motion sensor group. Therefore, the hybrid-computing navigation system including the wearable modified motion sensor group 25 and the mobile device obtains the moving direction of the user provided by the wearable modified motion sensor group 25.

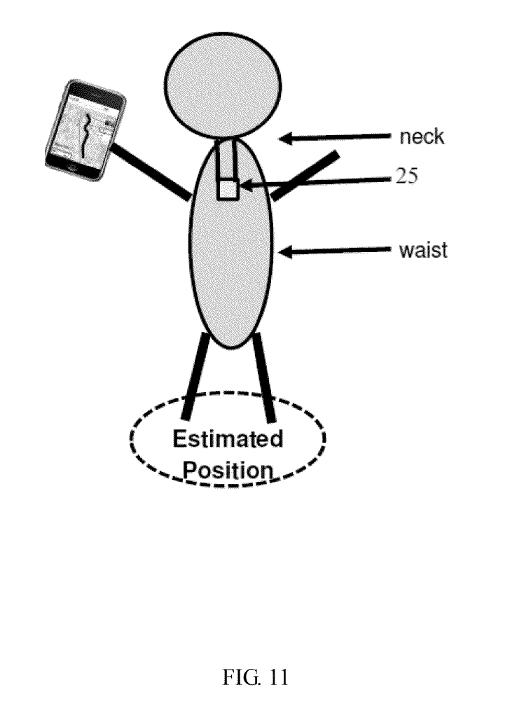

In FIG. 11, according to one more embodiment of the present invention, a motion sensor group 25 is disposed in a necklace which the user wears around his neck, such that the moving direction of the user is the same as the heading direction of the motion sensor group 25. Therefore, the hybrid-computing navigation system which includes the motion sensor group 25 and the mobile device obtains the moving direction of the user provided by the motion sensor group 25 disposed in a necklace.

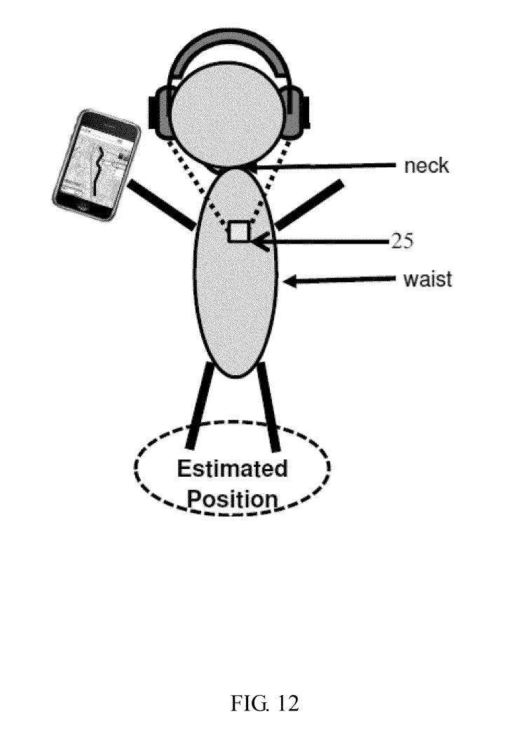

In FIG. 12, according to yet one more embodiment of the present invention, a motion sensor group 25 is disposed between the neck and the waist of the user, and the motion sensor group 25 is connected to a headphone. The moving direction of the user is the same as the heading direction of the motion sensor group 25. The navigation system including the motion sensor group 25 and the mobile device obtains the moving direction of the user provided by the motion sensor group 25. The mobile device provides a customized location-based map experience, a customized sound message for navigation information or a commercial advertisement according to the Wi-Fi positioning method, map matching technique or the 10-axis motion sensor (sensor fusion) result. The user wears the headphone to receive audio guidance provided by the mobile device.

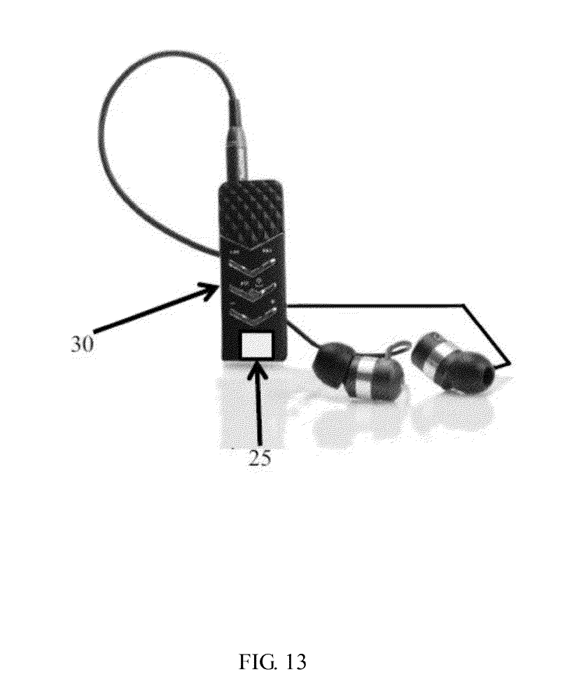

In FIG. 13, according to still another embodiment of the present invention, the motion sensor group 25 is embedded in a headphone transceiver 30. The headphone transceiver 30 provides a headphone jack (not shown) such that the user has the freedom of selecting his favorite headphone to use.

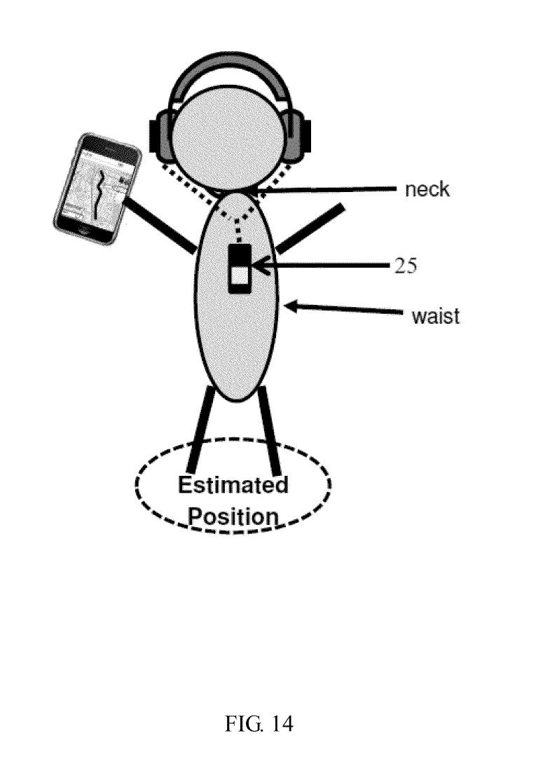

In FIG. 14, according to still yet another embodiment of the present invention, a motion sensor group 25 is embedded in the wireless transceiver, such as a Bluetooth transceiver, but limited to thereto. The wireless transceiver may take advantage of wireless transmission protocols, such as, Wi-Fi, Bluetooth, 3G networks or the combination thereof. The Bluetooth transceiver is disposed between the neck and the waist of the user, and the motion sensor group 25 is connected to a headphone. The moving direction of the user is the same as the heading direction of the motion sensor group 25. The hybrid-computing navigation system including the motion sensor group 25 and the mobile device obtains the moving direction of the user provided by the motion sensor group 25. The mobile device provides real-time map data, audio for navigation or advertisement message according to the Wi-Fi positioning technique, map matching technique, and 10-axis motion sensor (sensor fusion) technique. The user wears the headphone to receive audio guidance provided by the mobile device or via the Bluetooth transceiver.

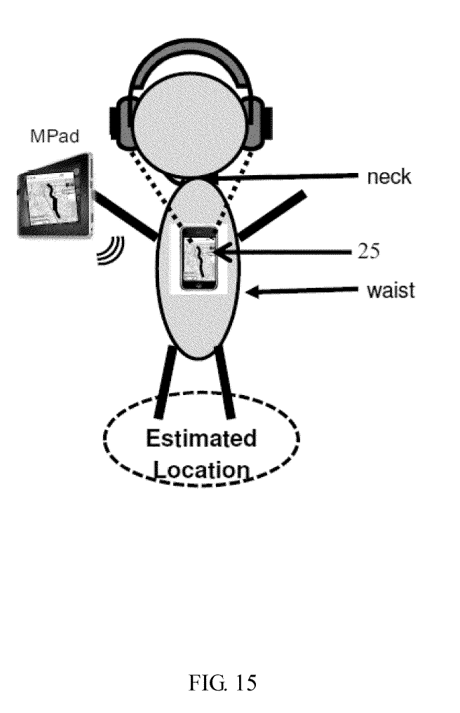

In FIG. 15, according to a second embodiment of the present invention, a motion sensor group 25 is embedded in the mobile device. The mobile device is disposed between the neck and the waist of the user, and the motion sensor group 25 is connected to a headphone. The moving direction of the user is the same as the heading direction of the motion sensor group 25. The hybrid-computing navigation system with the motion sensor and the mobile device obtains the moving direction of the user provided by the motion sensor group 25. According to Wi-Fi positioning, map matching technique or 10-axis motion sensor (sensor fusion) technique, the mobile device provides the relevant map image, sound or advertisement for navigation to a tablet computer, such as MPAD from CyWee Group Limited. In other words, the mobile device can send data for providing map function, sound or the advertisement for navigation to the tablet computer. The user wears the headphone to receive pronunciation or audio guidance provided by the mobile device or via the MPAD. In the second embodiment, the user may receive audio guidance from the speaker of the mobile device or MPAD.

In the embodiments of the present invention, a host device can be for example, a mobile device, or a MPAD.

It will be apparent to those skilled in the art that various modifications and variations can be made to the structure of the present invention without departing from the scope or spirit of the present invention. In view of the foregoing, it is intended that the present invention cover modifications and variations of this invention provided they fall within the scope of the following claims and their equivalents.

What is claimed is:

1. A navigation system worn by a user, comprising:
a motion sensor group, comprising a plurality of motion sensors, the plurality of motion sensors are built-in motion sensors worn by the user; and
a host device, configured for providing navigation information to the user, wherein the modified motion sensor group is worn on one or more parts of the user so that a moving direction of the user is the same as a heading direction calculated from the motion sensor group.

2. The navigation system as claimed in claim 1, wherein the plurality of motion sensors comprise a G sensor, a gyro sensor, and a magnetic sensor.

3. The navigation system as claimed in claim 2, wherein the motion sensor group provides step counting and absolute orientation in yaw, roll and pitch using a sensor fusion.

4. The navigation system as claimed in claim 3, wherein the sensor fusion comprising 9-axis motion sensors and 1-axis altimeter.

5. The navigation system as claimed in claim 4, wherein using 10-axis sensor fusion, and further comprising a wireless sensor to perform sensor fusion for obtaining an absolute position of an estimated position of the user.

6. The navigation system as claimed in claim 4, wherein using 10-axis sensor fusion, and further comprising a wireless sensor to perform the sensor fusion for obtaining an absolute position and calibration for the error of 10-axis motion sensors.

7. The navigation system as claimed in claim 4, wherein using 10-axis sensor fusion and combining with a location map to perform location map matching and fingerprinting.

8. The navigation system as claimed in claim 1, wherein the plurality of motion sensors communicate with the host device to send sensor data to the host device.

9. The navigation system as claimed in claim 1, wherein the plurality of motion sensors are further connected to an ear phone for receiving audio guidance from the host device.

10. The navigation system as claimed in claim 1, wherein the motion sensor group is disposed between a neck and a waist of the user.

11. The navigation system as claimed in claim 1, wherein the plurality of motion sensors includes at least one G-sensor, at least one gyro-sensor, at least one magnetic-sensor, and an altimeter.

12. The navigation system as claimed in claim 1, wherein the motion sensor group is embedded in a wireless transceiver.

13. The navigation system as claimed in claim 1, wherein the host device is a mobile device, the mobile device is connected to the motion sensor group, receiving a heading direction of the motion sensor group, and the heading direction of the motion sensor group is identical to a moving direction of the user.

14. The navigation system as claimed in claim 1, wherein the motion sensor group includes a G-sensor, a gyro-sensor, and an altimeter.

15. The navigation system as claimed in claim 13, wherein the mobile device comprises:
a motion processing unit, configured for obtaining a moving information in the coordinates of yaw, roll and pitch, extracting a gravity change and a linear acceleration from the moving information, and determining step counts by processing the linear acceleration; and
a position calculation unit, configured for calculating a traveling distance according to the step counts, and determining a current estimated position according to a previous estimated position, the traveling distance and the moving information.

16. A method of position estimation of a user, comprising:
obtaining a moving information in the coordinates of yaw, roll and pitch;
extracting a gravity change and a linear acceleration from the moving information;
determining step counts of the user by processing the linear acceleration;
calculating a traveling distance of the user according to the determined step counts; and
determining a current estimated position according to a previous estimated position, the traveling distance and the moving information.
